(19) United States
(12) Patent Application Publication
(10) Pub. No.: US 2005/0281276 A1
(43) Pub. Date: Dec. 22, 2005

(54) Data analysis and flow control system

(75) Inventors: Andrew Martin West, Hants (GB); Martin Redington, London (GB); Michael Paull, London (GB); Neil Forrester, East Sussex (GB); Alex Krzeczunowicz, London (GB); Martyn Pocock, Rutland (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Arion Human Capital Limited, London (GB)

(21) Appl. No.: 11/136,645

(22) Filed: May 23, 2005

Related U.S. Application Data
(60) Provisional application No. 60/574,089, filed on May 25, 2004.

(51) Int. Cl. H04L 12/28; H04L 12/56

(52) U.S. Cl. 370/411

(57) ABSTRACT

A computer implemented method and system for analysing and identifying the flow of internal and external communications in a large enterprise by collecting and analysing data relating to the information flow. The system comprises: a capture component adapted to capture communication activity data comprising communication data relating to the type of communication and organisational data relating to parties participating in the communication, the capture component further adapted to transform the communication data into a common format in dependence on the type of communication activity; an analysis component adapted to analyse the transformed data to identify patterns of communications and variances from previous patterns of communications; and, a presentation component adapted to present the data or results of data analysis.

### CROSS-REFERENCE TO RELATED APPLICATIONS

This application claims the benefit of U.S. Provisional Application Ser. No. 60/574,089, filed May 25, 2004, which is incorporated herein by reference.

### FIELD OF THE INVENTION

The present invention relates to a computer implemented system for analysing and identifying the flow of information within large institutions.

### BACKGROUND TO THE INVENTION

The management and communication of information is the key to success for all corporate organisations. Accurate and meaningful intelligence needs to be collected and disseminated rapidly to enable the organization to operate efficiently in a highly competitive environment.

The bigger the institution, the more complex becomes the problem of managing the information flows. For example, in a fully integrated investment bank, with different functions such as trading, research, fund management, corporate finance and mergers and acquistions, there is a need to disseminate information in a controlled and segregated manner. This is essential to avoid conflicts of interest and contain the potential misuse of confidential or price sensitive information. Currently, such control relies upon individuals to ensure that they compartmentalise information flows and do not communicate confidential information inappropriately.

Additionally, in the institution, technologies used to deliver these information flows have also become exceedingly complex. Over the years new communications networks have been introduced, for example email and instant messaging, and existing systems have been upgraded. As a result, communication data is stored on different machines, in different formats, in numerous locations and in numerous languages. It has therefore become exceedingly difficult to locate and identify the inappropriate communication of confidential information in real time, regardless of whether those communications are networked or non-networked (face-to-face).

Current technologies and procedures either seek to block inappropriate communications before these are transmitted or else to identify these communications post-event. Furthermore, it is currently not possible to identify patterns of communication activity that may indicate that a potential misuse of information will occur. A communication activity in the context of the present invention is defined to be any activity which involves two or more parties. These communication activities include such activities as telephone, email, instant messaging, trading and physical communication. The amount of data being collected with current systems has become so overwhelming that even identifying past patterns of behaviour has become an enormous task.

This inability to detect emerging patterns of behaviour, the accelerating complexity of the information flows and the sheer volume of data being generated has recently caused the existing structures for managing and controlling information and its flow within these complex institutions to fail.

The complex institution needs to demonstrate they have control over their information flows. They are currently achieving this by the use of multiple, piece-meal, stop-gap solutions, the cumulative effect of which is to introduce high levels of “information flow friction”, including the wholesale blocking of communication channels between departments and divisions. These sub-optimal solutions hamper both efficiency and competitiveness. Indeed, these solutions are particularly inefficient as the vast majority of these communications would occur in the normal course of business. No solution effectively addresses the problem tracking non-networked (face-to-face) communications which might indicate a violation of company policy and procedures.

Thus, there is an immediate need for a comprehensive solution that achieves the following objectives:
accommodates the increasing complexity and volume of message traffic
integrates information from a variety of sources, including networked and non-networked communications.
allows information to travel around the organisation with minimum friction
demonstrates that the organisation has control over its information flows
delivers regulatory compliance
provides a detection capability that identifies patterns of communication activity, including those that may indicate potential violations of company procedures and policies

A related problem concerns the identification of sales patterns and trends for a company's products and services and the relationship of these patterns and trends with communication activity.

In every highly-competitive, fast moving industry, the better and more immediate the customer information, the more competitive the institution. Currently sales managers possess a number of tools to measure sales effectiveness but these tools are lag indicators and do not exploit patterns of communication activity. Patterns of communication activity have a close correlation with sales performance.

Thus there is a need for a real time proactive capability that utilizes communication activities to:
identify emerging patterns of sales communication activities
identify trends in client coverage
identify patterns of communication activities by sales people and
measure effectiveness of the sales functions

### SUMMARY OF THE INVENTION

According to a first aspect of the present invention, a computer implemented method for identifying patterns of communication activity within an enterprise comprises the steps of:
capturing communication activity data relating to the communication activity, the data comprising communication data relating to the type of communication and organisational data relating to parties participating in the communication;
transforming the communication data into a common format in dependence on the type of communication activity;
analysing the transformed data to identify patterns of communication and/or variances from previous patterns of communications; and,
presenting communication activity data and/or the results of communication activity data analysis.

It is preferred that the step of capturing communication activity data includes the step of capturing location data and converting the location data into communication data. Typically, the captured data will be transferred from a capture server to a transformation server for the transformation step.

Preferably, the communication data comprises data selected from a group which includes: the parties to the communication; and, the type, identity, time, duration and location of the communication.

It is preferred that the method further comprises the step of capturing performance data relating to performance of the parties.

Preferably, the performance data comprises data selected from a group which includes: volumes of sales, values of sales, volumes of commission and values of commission.

Thus, a comprehensive and integrated method is provided for collecting communication activity related information within a large enterprise, processing or transforming the data into a common format, analysing it for patterns, and finally presenting the results in a simple form so as to be readily assimilated.

Preferably, the step of analysing comprises the step of identifing a prior pattern of communication activity relating to an event in order to establish a history of communication activity.

Preferably, the step of analysing further comprises the step of searching for a pattern of communication activity which would trigger an alert in dependence on a predetermined alert threshold. If such a variance in the pattern of communications is detected it is preferred that an alert is issued.

Thus, if as a result of analysis, a significant variation in the pattern of communications is identified, an alert may be issued. The pattern may indicate that a significant event has or will occur such as, a breach of internal protocol or regulatory compliance or significant change in sales activity for a particular client. In this scenario it is preferres that communications relating to an event which triggered the alert are located and retrieved, and it is desirable that references to this supporting evidence (i.e. relating to the significant behaviour identified in other communication channels) are included with the alert as it is issued. Subject to user configuration options, the system may execute predefined actions, such as blocking communications for one or more parties in the communication activity.

In this way, an automated and centralised method is provided for identifying patterns of communication in the enterprise, be these network communications or non-networked (face-to-face) communications. Automatic or user-instigated analysis permits significant patterns of communications to be identified and action taken.

According to a second aspect of the present invention, a system for analysing communication activity within an enterprise comprises:
a capture component adapted to capture communication activity data comprising communication data relating to the type of communication and organisational data relating to parties participating in the communication, the capture component further adapted to transform the communication data into a common format in dependence on the type of communication activity;
an analysis component adapted to analyse the transformed data to identify patterns of communications and/or variances from previous patterns of communications; and,
a presentation component adapted to present the data and/or results of data analysis.

Preferably, data records in the system contain a domain field which allows database information to be partitioned into different operational segments.

Preferably, the communication data comprises data selected from a group which includes: the parties to the communication; and, the type, identity, time, duration and location of the communication.

It is preferred that the capture component is further adapted to capture performance data, which is simply treated as an additional channel of data, but is otherwise treated in a similar manner to communication data.

Preferably, a system component is implemented as a server. Alternatively, a system component may be implemented as a plurality of servers. These arrangements allow each component to be scaled separately or to be distributed to other hardware. In particular, the capture component may comprise distributed capture servers in communication with a transformation server.

Typically, organisational data and each different communication modality will require a separate channel. It is preferred that each channel is implemented as a plug-in module within each server. New channels can be implemented as additional plug-in modules.

It is further preferred that each communication channel module will deal with one type of communication modality selected from a group which includes: all forms of telephone, instant messaging, e-mail, telex, facsimile, web mail and a physical location identification system. In this manner, the flow of all types of communication can be monitored separately and the communication data transformed into a common format, thereby facilitating analysis and the identification of patterns and variances between patterns.

Individuals operating within the enterprise will carry electronic identification devices that provide location information that can be monitored to give information on their location and hence non-networked communication channels. In one embodiement of this invention the location technology would be based on radio frequency identification (RFID). Other technologies may be employed such as wide area network (WAN) based location devices.

Preferably, a capture server module comprises an adapter to mediate capture of raw target data and to specify an appropriate form for the transformed data in dependence on the input format for a corresponding analysis module, the adapter comprising a transformation specification for specifying the data transformation.

Preferably, the analysis server comprises a reasoning engine or analytical tool package for performing queries and analysis on the data subject to user configurable options which tailor the operation to a particular environment.

In order to provide easy and centralised access to the captured data, it is preferred that the system further comprises a database coupled to each of the capture analysis and presentation components. Preferably, the database comprises a relational database.

In order that a user may submit queries, it is preferred that the system further comprises a data retrieval interface coupled to the capture, analysis and presentation servers. This interface provides a consistent mechanism for the retrieval of data for presentation, whether this is to be the results of analyses, online (adhoc) analysis (or querying), or access to the raw communication and organisational data. In one embodiment, the presentation interface may advantageously be a web-based interface.

In order that the user may perform other analysis, it is preferred that the system further comprises a data retrieval interface coupled to the raw communication data and or organsisational data.

Thus, the present invention provides a powerful and expandable system for identifying communications within an enterprise, and that furthermore is modular and can be configured according to the specific needs of the enterprise. In use, a variety of communication data is readily acquired and stored in a common format, thereby permitting automatic or user-instigated querying and analysis of the data, which can be presented and acted upon as required.

### BRIEF DESCRIPTION OF THE DRAWINGS

Examples of the present invention will now be described in detail with reference to the accompanying drawings, in which:

FIG. 1 shows a high-level overview of a system according to the present invention;

FIG. 2 shows the high-level partitioning of the capture, analysis and presentation functions;

FIG. 3 shows the high-level dataflows between capture, analysis and presentation modules;

FIGS. 4A and 4B show, respectively, a minimal and a distributed installation of the system using a server based architecture;

FIG. 5 illustrates the layer breakdown of the capture server functionality;

FIG. 6 shows an email channel in the capture server receiving data from four different mailservers;

FIG. 7 shows a high level overview of the analysis server functionality;

FIG. 8 shows the data retrieval interface to the analysis server in more detail.

FIG. 9 shows a detailed view of the repository, analysis, and results layers; and,

FIG. 10 illustrates a partitioning of the presentation server.

### DETAILED DESCRIPTION

The present invention provides a computer implemented system for analysing and identifying the flow of internal and external communications in large institutions by collecting and analysing data relating to the information flow. The system and methodology is known by the trade mark “Star-map”. One application of Star-map is to conduct an analysis of all types of communication behaviour between individuals or groups of employees. A communication in the Star-map context is defined to be an activity which involves two or more parties. This is an important concept in the Star-map system as it allows a wide range of activities to be transformed into the canonical form, which permits common analysis on wide set of data inputs. Advantageously, this may be used to identify, at an early stage, any unusual activity which may indicate the inappropriate use of confidential, privileged, price sensitive or high value information. A further application of this technology is to identify dynamic patterns of sales function communication activity or variations from recognised patterns of sales function activity, to provide an analysis of likely performance by sales people. These two applications of Star-map are described in more detail below.

The Star-map innovation recognises that only in very rare circumstances will information be systematically abused and that it is the systematic abuse of proprietary information that results in not only reputational risk but also generates detectable patterns. Star-map takes the approach that assessment by exception rather than an unsophisticated “catch all by blockage approach” is the correct solution to the management of the communication flows within a complex institution. The system can also be configured to identify possible individual abuse events. This approach differs substantially from any other capabilities available to the market. Star-map delivers a capability that will allow communications to flow freely between employees without loss of segregation or control and delivers the ability to detect systematic abuses of these information flows at an early stage.

A key feature of Star-map is that it provides the ability to capture and identify all the information flows between employees in the workplace, both networked communications and “non-networked communications”. This is achieved by identifying patterns of communication activity, within individual data sets and across the consolidated data. Once a variance is identified in one data set (e.g. phone calls), Star-map automatically cross references any supporting evidence of the variant pattern behaviour in other data sets (for example instant messaging or email). This provides a consolidated view of the variant behaviour, thereby capturing patterns of activity that indicate the misuse of information.

In every institution, every network communication, be it email, instant messaging (IM), telephone, trade or similar, leaves a communication signature. However, methods and processes for capturing and storing this data have been introduced over the years on an ad hoc basis and have not been integrated. Data is stored on different machines, in different formats and in numerous locations. Star-map's technology deals with this problem by accessing these disparate data files, converting a small subset of this data (communication headers, time stamps and other relevant details such as telephone number, recipient and sender) to a common format and consolidating the converted data onto a single data store. It does not need to access the content of the communication just meta information regarding the communication.

The Star-map architecture is intended to support multiple-capture, analysis, and presentation servers. Each capture server is assumed to maintain a configuration (recording the name, type, and other details for each data source), and also audit records for each data load. Each data load is assigned a unique sequence number and each record is intended to be traceable back to the original data file or data load from which it originated. However, this presents a problem. Consider a deployment with capture servers located in Tokyo and London, and an analysis server in London, whereby capture configuration and audit records are maintained locally by the Tokyo and London capture servers. When a query arises concerning the source of the record, it will be necessary to revert to the original capture server and consult the audit records in order to determine the source and time of data loading. This is a highly inelegant approach, but there are potential solutions, including:
a) Maintain the capture configuration and audit records in a database that is physically located with the analysis server. This is not an ideal choice, as database traffic will have to go over the network to perform the appropriate queries and updates, and the capture server will break if the analysis server(s) are inaccessible.
b) Send the capture audit data across to the analysis server, together with the raw canonical data, to be loaded into a local copy of the capture audit log. This should work with multiple capture and analysis servers, and permit local querying of the capture audit data, without referring back to the capture server itself. Another question concerns how the capture configuration data should be transferred. Preferably, this will be done using the customer's prefered file transfer mechanism, which could be one of ftp, secure ftp, rsync, a JMS application or an in-house application. Another open question concerns what should be sent across as the load identifier, as this identifier must be globally unique. However, a combination of an identifier for the capture server (perferably the server name), and a sequence number that is unique within the given capture server should suffice.

Once in a common format, and in a single location, Star-map's technology looks for patterns in communication within data sets that vary from previously identified and recognised patterns. Once an aberrant pattern is detected in one data group, Star-map identifies supporting evidence of the aberrant pattern behaviour in other data sets. It is essential to accumulate supporting evidence of the aberrant behaviour in order to minimise the number of false alarms (“false positives”) generated by the software. Once confirmed by the accumulated supporting evidence of the variance, an alert is deployed. Using exception management, Star-map provides an early-warning detection capability to information abuse.

As already indicated, Star-map's capabilities extend beyond the edge of the network to include face-to-face communications. Circumstances can arise where proprietary information is sought to be communicated outside of the network channels including, for example, the situation where non-authorised personnel enter and leave secure areas within the workplace, often by “tail-gating” behind authorised personnel.

Star-map captures these patterns of communication activity by location identification devices carried by each employee and visitor. These devices communicate with sensors installed in the suitable locations in the workplace, which then transfer employee location information to the Star-map system using the appropriate Star-map adapter.

This enables Star-map to identify patterns of meeting behaviour amongst people within the workplace and to identify interactions that do not comply with corporate policy and procedures. When a pattern of collusion has been identified, Star-map examines the consolidated network communication data to cross reference supporting evidence of the aberrant behaviour.

Once a significant pattern of communication events has been identified, Star-map will automatically examine the data log of all communication activity to deliver a consolidated view of all the communication activity between the parties to the identified communication event, be these networked or non-networked communications. An alert is then raised with this consolidated view of the communication activities.

Thus, Star-map delivers:
the ability to allow communications that should take place in the normal course of business to flow between employees without interruption and without loss of segregation or control
the ability to identify potentially inappropriate communications using assessment-by-exception
a consolidated database of all communications within the institution in a common format without converting and transferring the content of each communication
the ability to identify patterns of communication regardless of the complexity and volume of information flows
the ability to provide alerts when this analysis detects a deviation from recognised patterns of behaviour with a consolidated view of related communications

In this way, Star-map delivers a complete solution to the communication management problem facing the complex institution today. By using exception and pattern detection, Star-map allows the vast majority of communication activities which should occur in the normal course of business execution to flow with no “friction” between the appropriate participants.

As regards the application of the technology to the sales function in a large organisation, Star-map delivers a capability that allows the sales manager to identify and analyse all the communications between sales people and their clients. This is achieved by consolidating all the communication reference data relating to these communications, be these email, instant messaging, telephone communications or similar, onto a single database and representing these in a common format.

Once in a common format in a single location, Star-map is able to track each communication by the communication signature which is unique to each sales person. This does not require any additional input on behalf of the sales people or any change in behaviour.

Star-map applies an analysis component to the communication data, to identify emerging patterns of communication activity. The preferred implementation is achieved by way of a proprietry combination of constraint, deductive and reactive rules that are easily configured according to the circumstances to which the technology is being applied.

The sales manager is able to look at the frequency of communications in a number of ways: by sales person, by the frequency of communication with a particular client, by the ratio of incoming versus outgoing communications and so forth. Trends in coverage can be monitored and these trends related to trends in relationship profitability and transaction flow. Star-map also provides the ability to rank communications by frequency, by revenue generation, by sales person, by client, locally, regionally and globally, or by any other means that may be required by the sales manager.

Star-map also looks for communication patterns within data sets relating to possible or actual sales and identifies when these communication patterns vary from previously identified and recognised patterns. Once a trend or variance is identified in one data set, Star-map searches automatically for supporting evidence of the trend or variant pattern behaviour in other data sets. This provides a consolidated view of the trend or variant behaviour.

Star-map is a comprehensive business performance measurement application specifically tailored and designed to meet the demands of the complex, multi-regional sales-led institutions. It is a completely automated process, requiring no additional input or change in behaviour. It utilises data already available within the institution and is only concerned with the fact that an interaction has taken place, not with the content of that interaction. Star-map enables a direct link to be made between patterns of behaviour and business performance.

When applied to the sales function of a large organization, Star-map delivers:
the ability to manage, filter and analyse the consolidated data sets of all the network communication flows between the sales functions and its clients on a global basis
the ability to predictively identify emerging trends in client coverage and profitability
the ability to identify emerging patterns or variant client coverage, both within discrete data sets and across the consolidated data.

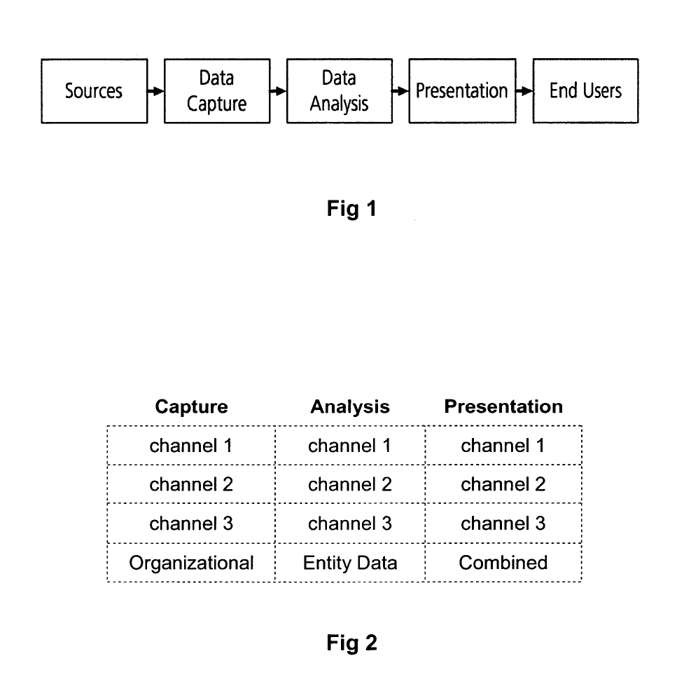

Having reviewed the key applications and associated advantages, we now consider the technology and architecture of the Star-map concept in greater detail. As shown in FIG. 1, at a high level the Star-map application has three main processes or components: capture (of data), analysis (of data) and presentation (of results to end users). Communication and other data is captured from external sources (all forms of telephone, instant messaging, e-mail, facsimile, web mail and physical location identification systems, etc). The data capture process includes preprocessing of the data, and its transformation into the common format for analysis. The data is then analysed, for significant communication patterns and events, and finally the results of that analysis are pushed to (alerting), or pulled by (reporting) end-users.

There are three fundamental types of data of importance for the application, communication data, organisational data, and performance data. Communication data describes the parties to the communication, the type, identity, time, duration and location of the communication. For example, a telephone call from an internal extension to an external number where the identity would contain calling and receiving numbers. The identity of a communication is specific to the type of communication. Communication data is specific to a particular channel modality, including telephone, e-mail, facsimile or instant messaging, but is not strictly limited to such communications.

An important subset of communication data is location data, which is concerned with the physical proximity of employee identity tags to reader devices spread throughout the physical environment. Location data is treated identically to other communications data, with the exception that the location data must be pre-processed or enhanced. For example, where two individuals are both standing near the same reader, at the same point in time, the enhancement process will detect this event and generate a “meeting”, even for the two employees. Typical third party location systems do not detect meetings or communication, but simply the proximity of a reader and card.

The second type of data, organisational data, can be divided into two further sub-classes. One subclass, “entity data”, describes business relevant entities, such as employees, groups, departments and products, and their relationship to each other (for example, which employees belong to which department). A second subclass, “addressing data”, relates these business entities to the endpoints, or addresses, that occur in the communication data. To a first approximation, this second subclass is channel specific. Typically, the sources of addressing data will be more varied and less accessible than the communication data. In extreme cases, some degree of manual entry may be required.

The third type of data, performance data, describes measurements of job-related performance. For example, the number and/or volume of sales for a particular individual and client.

Within the Star-map application, all data is marked as belonging to a particular domain. All analysis is performed on a per-domain basis, and information from different domains is never integrated. This allows the analysis of data from multiple institutions or entities within a single deployment of the Star-map application, and allows test data to be run alongside production data.

As shown in FIG. 2, the application can be partitioned both “horizontally”, across its high level components (data capture, analysis, and presentation), and “vertically” according to the channel or modality of the communication data it captures. As illustrated, an additional data capture module is required for organisational data, which for now we will assume captures both entity and addressing data. This additional module has submodules for capturing addressing data associated with different channels, which is then fed to the channel specific analysis module.

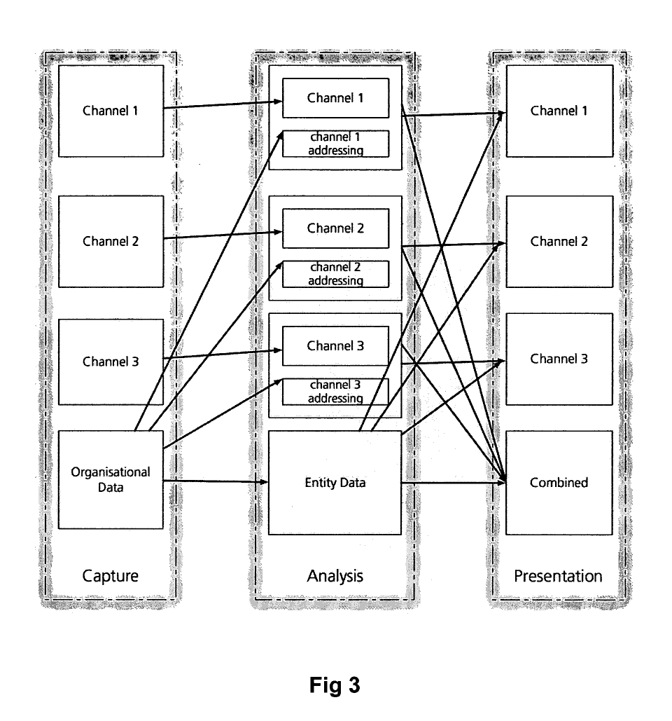

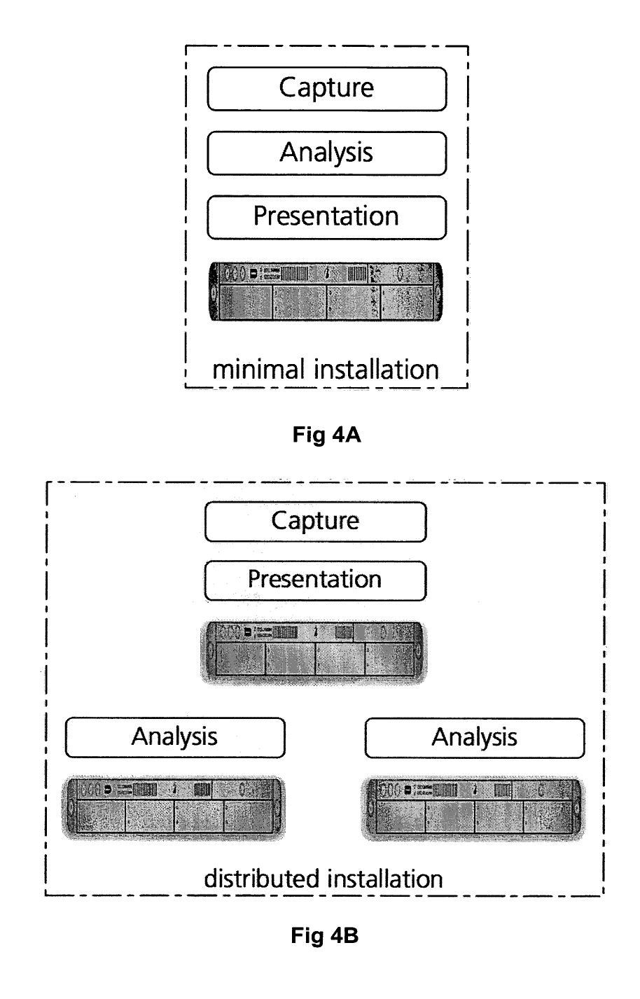

In the high level model described above, data flows from capture through to presentation with no communication or interaction between channels, except that analysis and/or presentation modules for a given channel will need to access the organisational entity data. FIG. 3 illustrates the data flows between modules in more detail. Where analysis or presentation of combined data from multiple channels is required, it is assumed that separate analysis and presentation modules will handle this. One architecture that supports such partitioning is to implement the capture, analysis and presentation functions as separate servers. Under this arrangement, a minimal Star-map installation would consist of a capture server, an analysis server, and a presentation server, as shown in FIG. 4A. An advantage of the server approach is that it allows each function to be scaled seperately, as shown in FIG. 4A, or to be distributed to more powerful hardware. FIG. 4B shows an example where the analysis function is distributed to two servers.

Ideally, scalability across nodes is relatively transparent from an administration perspective, implemented by a master-slave arrangement for clusters of servers. Within each server, each channel is implemented as a plug-in or module. For example, the analysis server would have an email module, a telephone module, an entity data module, and the like. Each module corresponds to one of the individual cells in the high level diagram of FIG. 2.

The server provides commonly required facilities to the module, such as persistent storage, transformation and query services, so that module implementations are kept as small as possible. Ideally, the modules will be configured using an xml specification. In practice, this may not be possible, and the module model will require some modification, but the approach is satisfactory for a high level characterisation.

Although there will be strong dependencies between the capture, analysis, and presentation modules for a given channel, as each stage provides input for the next, this does not mean that there is any necessary dependency between the function specific servers themselves. As long as the data capture server produces data suitable for the analysis server to work with, the analysis server does rely upon the actual implementation of the data capture server.

In one representation, communication between the data capture and data analysis components consists mainly of row based messages, or real-time messages that are equivalent to row-based messages, and so a simple file or stream-based interface will be largely sufficient. Communication between the analysis and presentation components will consist largely of queries and result sets, or event notification. Although this interface will typically be more complex than the corresponding boundary between the data capture and analysis functions, it is possible to standardise the interface and to decouple the analysis and presentation implementations.

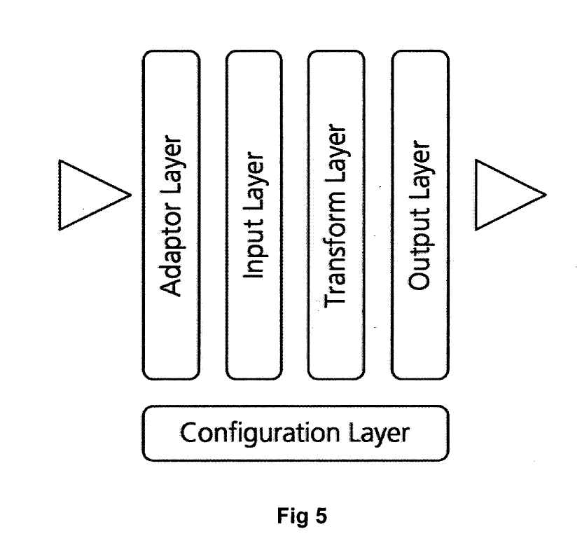

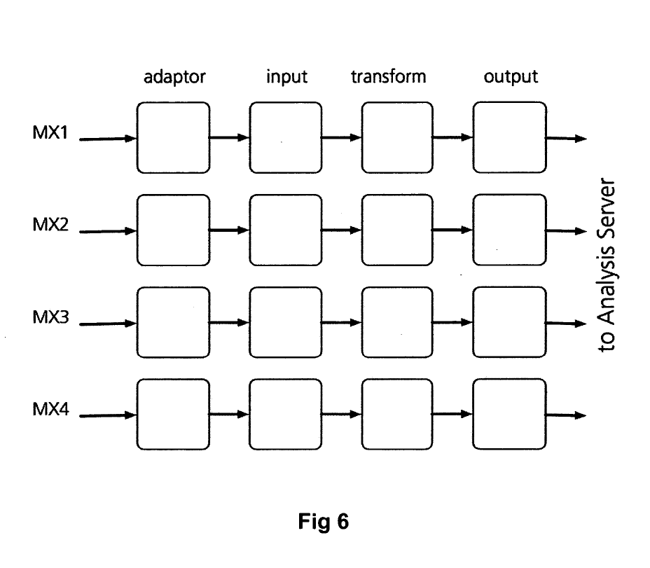

A high-level view of the capture server functionality is shown in FIG. 5, with the various layers indicated. In one embodiment the processing is stream based, with data arriving from named sources, in batches, or in real-time. The adaptor layer isolates the main processes from the implementation details of individual feeds, thereby acting as a buffer. The input layer then simply passes data from these feeds through to the transform layer. The transform layer converts the “raw” data from the source into a format suitable for presentation to the analysis server. For example, a mail-log might be converted into a table-based format, suitable for loading into a database via a bulk copy process.

The operation of the capture server can be illustrated by considering a single channel for the server. For example, an email channel capturing data from four different mailservers (MX1 to MX4), as shown in FIG. 6. In general, it will be necessary to separately configure the adaptors for each of the four sources, which might be, for example, remote file pulls, local file-system reads, or some kind of record based real-time interface. However, they can often be utilised and applied across multiple channels. The input and output configurations are relatively straightforward.

A large part of the channel specific functionality resides in the transform configuration, since the transform layer must convert data from one of a (preferably small) number of channel specific input formats into a fixed canonical format for that particular channel. The format should also be suitable for the downstream analysis server. For many channels, the required transformations will generally be small in number and relatively simple and straightforward. This is less likely to be true for organizational data, where a much greater variance in the data formats is to be expected. For other channels, such as location data, it may be preferable to perform some early processing during transformation. An example would be the conversion of location device information readings into physical location data, i.e. room and floor number. At this point, it is noted that feeds may not be completely independent from one another. For example, the feeds from different sources may be combined, either prior to or post transformation.

A capture server “module”, permits data collection for a new channel, potentially will consist of a set of specialised adaptors and a set of transformation specifications. The output of the transformations will be determined by the requirements of the analysis module for that channel. The module will also need to provide adaptors and transformer configurations for any associated addressing data. Organisational data can be treated as an additional separate channel with its own module, which will typically require more flexibility. As the following example illustrates, the capture server configuration will ideally be implemented as xml:

```
<?xml version=“1.0” encoding=“UTF-8”?>
<mon:monitor
  xmlns:mon=“http://adapters.starmap.net/monitor”>
  <mon:domain name=“arionhc”/>
  <mon:verbose level=“1”/>
  <mon:sleep interval=“10”/>
  <mon:dir name=“dropin/msexchange”
    handler=“run-msexchange-adapter”
    suffix=“log”
    domain=“yes”
    output=“dropin/canonical”>
  </mon:dir>
  <mon:dir name=“dropin/sendmail”
    handler=“run-sendmail-adapter”
    suffix=“log”
    domain=“yes”
    output=“dropin/canonical”>
  </mon:dir>
  <mon:dir name=“dropin/canonical”
    handler=“run-canonical-loader”
    suffix=“csv”>
    <mon:postprocessing>
      <mon:rollup
        handler=“run-rollup”
        domain=“yes”
        timeIntervalCode=“DAY”
        localOrganisationExternalId=“00”/>
      <mon:analysis handler=“run-analysis”/>
    </mon:postprocessing>
  </mon:dir>
</mon:monitor>
```

The entity and addressing data may be external or internal to the organization and there may be a requirement to pull data automatically from external sources (e.g. reverse lookups of telephone numbers). In other cases, it may be necessary to actively request addressing information from the adminstrator or operator. For example, to map e-mail traffic from a common domain to a single client organization.

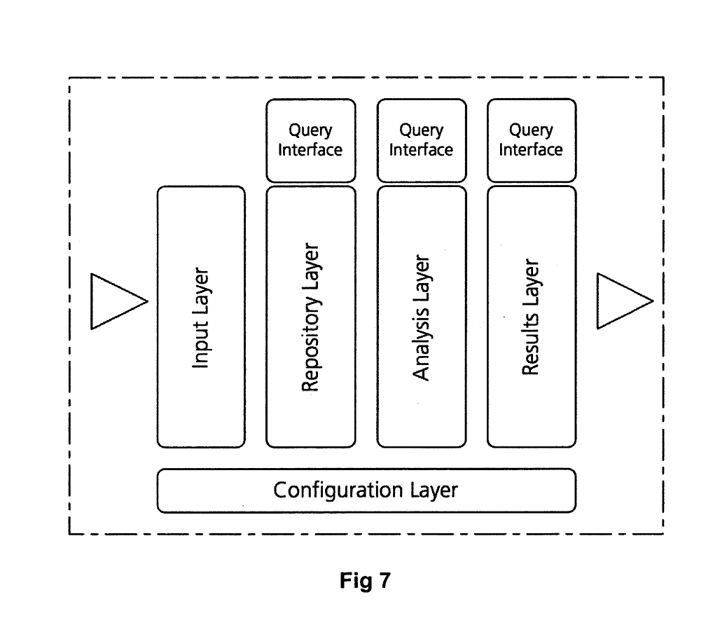

We now move on to the next key stage and consider the implementation of the analysis function, beginning with a high level view of the analysis server architecture, as shown in FIG. 7. The input layer of the analysis server simply collects the output of the capture server, whereas the repository layer of the analysis server will generally contain canonical representations (e.g. fixed schemas) for particular channels, which determine the output format that the capture server is required to produce. An example canonical format for telephone data might consist of a relational database table storing source and destination numbers, and the time and duration of the call. Some flexibility is required in schema generation and installation, as typically the schemas for entity data will be relatively variable across different installations. That is to say, different sectors or companies will have different structures.

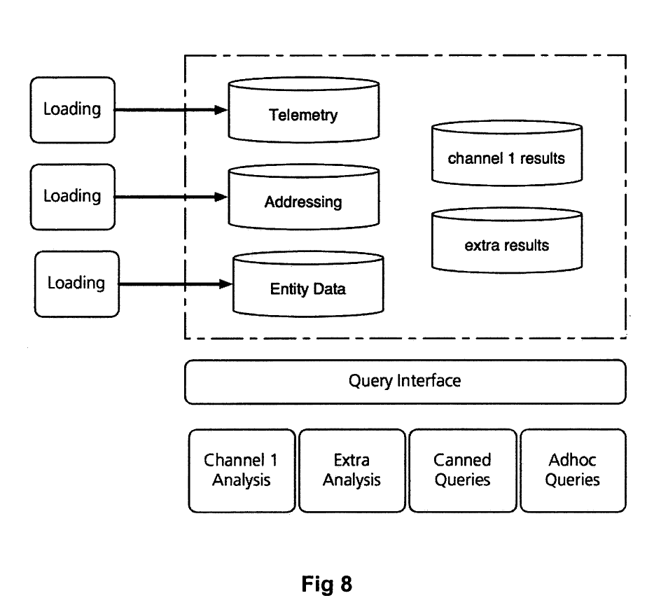

The analysis layer of the server performs the actual analysis of the data and, where appropriate, the results of these analyses are stored in the results layer for later retrieval. A data retrieval interface provides a consistent mechanism for the retrieval of data for presentation, whether this is to be the results of analyses, online (adhoc) analysis (or querying), or access to the raw communication and organisational data. This facility is shown in a little more detail in FIG. 8, where data from a communication channel and organisational data (entity, addressing) is loaded and available for analysis and querying through the interface. It is noted here that, for auditing reasons, the schemas should support tracking of the data source.

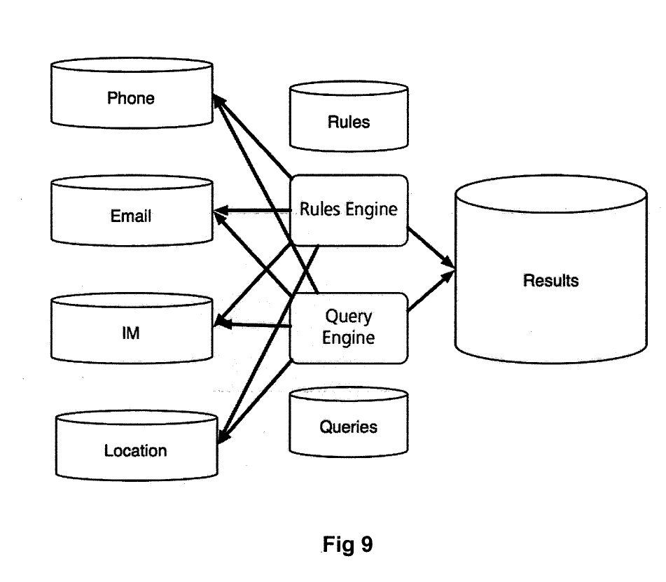

FIG. 9 shows a slightly lower level view of the repository, analysis, and results layers. As illustrated, the analysis layer consists of a number of anaysis modules, each of which provides a specific kind of analysis that can be applied to the captured data. One module shown here is a rules analysis module, which determines whether or not specific communications comply with company policy, as embodied in the rules which make up the configuration module. For example, a rule may indicate that employees in department A may not communicate directly with employees in department B.

A second kind of analysis module that is shown here is a relational query engine, which allows the communication information to be queried directly, in order to retrieve either individual records or agreggate data (e.g. the number of phone call made an individual, or a set of individuals for a given period of time).

A third kind of analysis module is the data rollup analysis module, that calculates summary statistics, to enable reporting and further analysis of communication patterns to be performed efficiently.

A fourth kind of analysis module is the pattern analysis module, which constructs profiles of communication patterns by measuring the number of communications of each type between an individual or group, and another set of individuals or groups. These profiles can be compared by calculating a measure of similarity over the resulting vectors, where each element of the vector represents the number of calls to a single individual or group. Comparisons allow the detection of novel patterns of communication, where the similarity measure is below a certain threshold, either over time or between groups and individuals.

A fifth kind of analysis module calculates distance and connectedness metrics based on the theory of Social Network Analysis. These measures are determined by the shortest communication path between two parties, given previous communications, and the number of parties with which an individual or group communicates with. The measures are useful as an indicator of communication efficiency, and possible routes of information dissemination throughout the organisation.

Other additional analysis modules may provide additional analysis capabilities or techniques.

The rules, queries, and other parameters that are fed into the appropriate analysis module are part of the configuration information for the analysis server. Some of these configuration parameters may be highly customised, whereas others will be standard sets for particular modalities or channels. This configuration information is organised as a series of “analysis packages”, which can be flexibly deployed to suit a particular installation. The results schema for storing the output will typically also be included within the relevant analysis package.

The data retrieval interface, which is not shown in FIG. 9, provides access (for the presentation layer) to data held in the repository and results layers, as well as adhoc analyses via the analysis engines. It is instructive to consider some of the configuration information required for the analysis server for a single channel.
1. Loader configuration. One per feed. At the minimum, this will indicate where to retrieve a file (for a bulk copy process and the like)
2. Canonical representations for the channel specific communication and addressing repository schemas. These will typically be fixed.
3. Channel-specific analysis packages, for example comprising rules and queries, and results schemas, and
4. Customer or application specific analysis packages

The analysis server can be expanded further by adding additional channels, additional analysis engines (similar to the rules and query engines), or additional analyses packages (for an engine that is already installed).

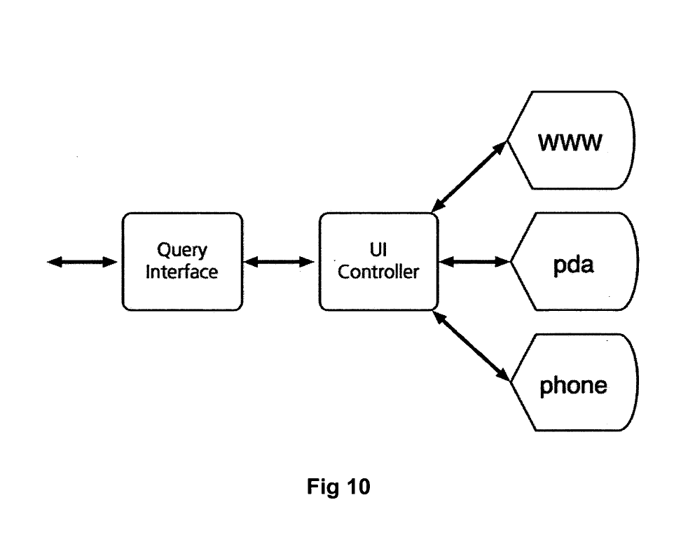

Finally, we consider the presentation component of the system, for which a high level overview is shown in FIG. 10. The data retrieval interface illustrated here talks directly to the data retrieval interface(s) of one or more analysis servers. The user interface controller (UI Controller) co-ordinates interaction between the front end user interfaces and the data retrieval interfaces. Data that has been retrieved must be transformed prior to presentation, either for the user interface or for the display device. This process is not shown explicitly in FIG. 10.

The presentation server functionality is fundamentally partitioned by the nature of the analysis that is performed on the data, and the communication channel(s). For example, one function might report the results of the application of a rules-based analysis to telephone call records, while another present the results of a relational query, run on email traffic records. The presentation server requires a modular architecture similar to the capture and analysis servers, so that additional channels and analysis engines can be accommodated.

The initial output of the presentation layer will be device neutral, for example extensible mark-up language (xml), so that it can be transformed according to the requirements of a particular display device. Example devices include a World Wide Web (www) interface, personal digital assistant (PDA) and telephone.

As discussed above, data is canonicalised into the common format, then it becomes available for subsequent querying and analysis via a canonical data access interface (CDAI) as discussed earlier and referred to previously as the query interface. The CDAI presents a consistent, object-oriented view of the communications data. For example, at the top of the class hierarchy for communications would be a communication object, with subclasses representing different types of communication, such as email, instant messaging, phone calls, and physical proximity and data from other sources. The presentation server also supports retrieval of the underlying messages or communications content, where these are accessible from archiving systems, and can be retrieved by means of the message identifiers imported into the Star-map system. Note that this capability relies on message archiving systems external to Star-map. The Star-map application itself does not store any actual commmunications content.

Business entities such as individuals, groups, departments, buildings, offices, and companies, which are the endpoints of communications are also represented as classes in the CDAI.

This object oriented interface allows queries on the underlying data to be expressed concisely, across communication modalities. The query and analysis modules do not require any knowledge of the details of the underlying canonical representation(s) of the data.

Consider for example, email traffic. All email messages have the following properties:
from_address
to_addresses
cc_addresses
date sent
date received [for inbound]
message_id [a unique id assigned by the originating mail server]

Mail systems typically store this information in a mail log, that is separate from the actual emails themselves. The exact format of the mail log is dependent on the specific mail server (e.g., windows exchange server, Domino, Open Exchange, sendmail, postfix, etc). Specific email adapter modules will capture email log data and convert into the common format.

An implementation of a postfix adapter for the Star-map system would handle the capturing of this data, and its transformation into a canonical format for querying, as follows:
Capture: The log file delta changes are pulled from the mail server log. Alternative implementations may push the changes to the capture module.
Transformation: The supplied transformation specification is prepared. This describes the mapping from the native format of the mail log to the “standard file format”.

Unix postfix mail log entries as follows:
May 19 02:08:02 localhost postfix/pickup[749]: E6964C3E54: uid=501 from=<martin>
May 19 02:08:03 localhost postfix/cleanup[750]: E6964C3E54: message-id=<20040519010802. E6964C3E54@gabriel.saggyoldclothcat.com>
May 19 02:08:03 localhost postfix/qmgr[451]: E6964C3E54: from=<martin@saggyoldclothcat.com>, size=525, nrcpt=4 (queue active)
May 19 02:08:03 localhost postfix/smtp[752]: E6964C3E54: to =<adam@sosume.org>, relay=autonomous.co.uk[81.3.86.177], delay=1, status=sent (250 Message received)
May 19 02:08:03 localhost postfix/smtp[753]: E6964C3E54: to =<mredington@star-map.net>, relay=mx-01.dnsmaster.net[212.84.161.12], delay=1, status=sent (250 ok 1084928882 qp 19070)
May 19 02:08:03 localhost postfix/smtp[753]: E6964C3E54: to =<nforrester@star-map.net>, relay=mx-01.dnsmaster.net[212.84.161.12], delay=1, status=sent (250 ok 1084928882 qp 19070)
May 19 02:08:09 localhost postfix/smtp[754]: E6964C3E54: to =<mjc@zuaxp0.star.ucl.ac.uk>,
relay=vscan-b.ucl.ac.uk[144.82.100.151], delay=7, status=sent (250 OK id=1BQFZ4-0004Cy-Ec)

A transformation specification for this format might be as follows:

date ; (“$1 $2 $3”)
message_identifier ; $6 =˜ /([A-Z0-9])\:/
message_uid ; $5 =˜ /postfixVcleanup/ ; $7 =˜ /message-id=<(.*)>$/
from ; $5 =˜ /postfixVqmgr/ ; $7 =˜ /from=<(.*)>$/
to ; $5 =˜ /postfixVsmtp/ ; $7 =˜ /to=<(.*)>$/
output ; message_uid|date|from|to

where the first field (fields are semi-colon separated here) indicates the name of the property of the message.

For entries with only two fields, the second field is an expression defined in terms of the white space separated fields of the mail log entries (where $1, $2, $3 refer to the first, second and third fields, respectively), and in regular expressions, which can be matched against the indicated fields of the mail log, and used to select a subset of the field.

For example, $7=˜/to =<(.*)>$/, when matched against to=<nforrester@star-map.net>, will select nforrester@star-map.net

For entries with three fields, the second field is a regular expression that must match the specified field. If the expression matches, then the value of the property will be derived from the regular expression match of the third field. Likewise the following specification:
$5=˜/postfix\/qmgr/; $7=˜/from=<(.*)>$/
   will populate the from_address property, based on the specification “$7=˜/from=<(.*)>$/”, but only when the expression “$5=˜/postfix\/qmgr/” also matched the line.

The “output” entry defines the output format for each message, in terms of the previously defined properties.

Although this example is specified in terms of fields and regular expressions, the exact nature of the transformation engine is not critical, and there may be various different transformation engines and transformation specification languages. For example, extensible style sheet language (xsl) transformations of xml data.

All that is necessary is that the transformation used is capable of outputting data in the standard file format for the communication modality. The standard file format is a record based format, where (in this particular case), each record represents the data for a single email message. For example, the format might be pipe-delimited, with multiple to or cc addresses being separated by commas. For example:
msg_id|date sent|date received|from_address|to_addresses|cc_addresses|domain
   The format is intended for storage on disk, although in practice, for efficiency, the transformed data may be simply piped through to the next stage.

The loading process consumes data in the standard file format, and loads this data into the persistent store. This may be a relational database, but might also be a file system. In either case, the data is initially unprocessed, and essentially remains in the standard file format.

The canonicalisation process consists of two separate stages.

1. Reorganisation: The data is is transformed from the standard file format into the canonical format, which is optimised for performing queries and analysis of the data. Multiple representations might be required, to support the efficient processing of different kinds of queries and analysis.

For example, a relational representation of the email data might have separate tables for addresses and messages, with relations between the tables indicating which addresses originated, or received which messages. This representation would support efficient querying using relational operators.

An alternative representation might be vector based, with values in the vectors indicating the number of specific addresses that were sent from the address represented by the vector, to the address represented by the element of the vector. This would support efficient comparison of individual's communication profiles: the occurrence, or non-occurrence of communication with similar sets of people.

2. Entity mapping: The endpoints specified in the message record (i.e. the email addresses) are mapped to employees of the firm, or external third parties (e.g. customers or suppliers). These entities are business relevant, whereas the email addresses, in themselves, are of no direct business relevance. This allows queries to be made in terms of business relevant entities (clients, customers, etc.), instead of arbitrary labels (email addresses).

From the postfix log above the email addresses would be mapped to organisational entities as follows:
<martin@saggyoldclothcat.com> to Martin HigginBottom, Accounts
<adam@sosume.org> to Adam Stephens, Payroll
<mredington@star-map.net> to Martin Redington, IT Support
<nforrester@star-map.net> to Neil Forrester, Support Manager
<mjc@zuaxp0.star.ucl.ac.uk> to Martin Clayton, Customer Education
   This would result in a common format record as shown in Table 1 below.

Once the data has been canonicalised, then it becomes available for subsequent querying and analysis. Analysis and query modules access the data via a canonical data access interface (CDAI). The CDAI presents a consistent, object-oriented view of the communications data. For example, at the top of the class hierarchy for communications would be a communication object, with subclasses representing different types of communication, such as email, instant messaging, phone calls, and physical proximity.

Business entities such as individuals, groups, departments, buildings, offices, and companies, which are the endpoints of communications are also represented as classes in the CDAI.

This object oriented interface allows queries on the underlying data to be expressed concisely, across communication modalities. The query and analysis modules do not require any knowledge of the details of the underlying canonical representation(s) of the data.

TABLE 1

| Field | Contents |
|---|---|
| Parties to the communication | Martin HigginBottom, Accounts |
| | Adam Stephens, Payroll |
| | Martin Redington, IT Support |
| | Neil Forrester, Support Manager |
| | Martin Clayton, Customer Education |
| type | email |
| identity | <20040519010802.E6964C3E54@gabriel. |
| | saggyoldclothcat.com> |
| time | 20040519010802 |
| duration | 0 |
| location | vscan-b.ucl.ac.uk[144.82.100.151] |
| domain | TEST |

Let us now consider how this process would be applied to telephone call log data. We describe the implementation for an IPC system. Other types of telephone system would follow a similar pattern. The following is an record from a telephone call log, extracted from an IPC call logging system:
000560011708200068002101685009107398353139;00;;000000000

This particular record indicates that internal line 00056, operated by employee 00068, in employee group 002 made an outbound call on line number 01685, at epoch 1073983531 (seconds since Jan. 1, 1970), for 39 seconds.

The transformation specification for this record type, in the language described above, would be as follows:

message_uid ; $0
from ; $0 =˜ /\hat{ }(.{5})/
to ; $0 =˜ /\|(.{5})/
from_group: =˜ /(.{3})\|/
date: $0 =˜ /\|.{8}(.{10})/
duration: $0 =˜ /\|.{18}(.*)\;/
output ; message_uid|date|duration|from|from_group|to

This produces output in the standard file format for telephone calls, which can then be loaded and canonicalised as before.

Critically, during canonicalisation, the endpoint identifiers present in the call log records will be mapped to the business relevant identifiers corresponding to actual employees and organisational identities (groups, departments, and clients), producing a common format record as shown in Table 2.

TABLE 2

| Field | Contents |
|---|---|
| Parties to the communication | Martin HigginBottom, Accounts |
| | Adam Stephens, Payroll |
| type | phone |
| identity | 560011708200068000 |
| time | 20040519010802 |
| duration | 39 |
| location | Bldg: 1 Floor: 4 Room: 32 |
| domain | TEST |

Let us now consider how this process would be applied to location data. The following are records from a location tracking system.
092175 20040519120053 4 6
034874 20040519120053 4 6

This record indicates that employees 092175 and 034874 were in location 6, on floor 4, at 12:00:53, on the 19 May 2004.

A transformation specification for these records might appear as follows:

message_uid ; $0
employee_id ; $1
date ; $2
location ; “$2$3”
output ; employee_id|date|location|message_uid

This produces output in the standard file format for location data, which can then be canonicalised as before resulting in a common format record as shown in Table 3.

TABLE 3

| Field | Contents |
|---|---|
| Parties to the communication | Martin HigginBottom, Accounts |
| | Adam Stephens, Payroll |
| Type | Location |
| Identity | 46 |
| time | 20040519120053 |
| duration | 60 |
| location | Bldg: 1 Floor: 4 Room: 32 |
| domain | TEST |

The process for other sources of data follows the same pattern.
Capture: Changes are pulled from the source. Alternative implementations may push the changes to the capture module.
Transformation: For each feed, a transformation specification is prepared.
Loading and Canonicalising the standard format data into the database or file system.

1. A computer implemented method for identifying patterns of communication activity within an enterprise comprising the steps of:
capturing communication activity data relating to the communication activity, the data comprising communication data relating to the type of communication and organisational data relating to parties participating in the communication;
transforming the communication data into a common format in dependence on the type of communication activity;
analysing the transformed data to identify patterns of communication and/or variances from previous patterns of communications; and,
presenting communication activity data and/or the results of communication activity data analysis.

2. A method according to claim 1, wherein the step of capturing communication activity data includes the step of capturing location data and converting the location data into communication data.

3. A method according to claim 2, wherein the communication data comprises data selected from a group which includes: the parties to the communication; and, the type, identity, time, duration and location of the communication.

4. A method according to claim 1, further comprising the step of capturing performance data relating to performance of the parties.

5. A method according to claim 4, wherein the performance data comprises data selected from a group which includes: volumes of sales, values of sales, volumes of commission and values of commission.

6. A method according to claim 1, wherein the step of analysing comprises the step of identifing a prior pattern of communication activity relating to an event in order to establish a history of communication activity.

7. A method according to claim 6, wherein the step of analysing further comprises the step of searching for a pattern of communication activity which would trigger an alert in dependence on a predetermined alert threshold.

8. A method according to claim 7, further comprising the step of issuing an alert in dependence on a variance in the pattern of communications.

9. A method according to claim 8, wherein the step of analysing further comprises the step of locating and retrieving communications relating to the event which triggered the alert.

10. A method according to claim 9, wherein the alert includes communications data relating to the identified variance in the pattern of communications.

11. A method according to claim 7, further comprising the step of blocking communications for one or more parties in dependence on the pattern of communication activity.

12. A system for analysing communication activity within an enterprise comprising:
a capture component adapted to capture communication activity data comprising communication data relating to the type of communication and organisational data relating to parties participating in the communication, the capture component further adapted to transform the communication data into a common format in dependence on the type of communication activity;
an analysis component adapted to analyse the transformed data to identify patterns of communications and/or variances from previous patterns of communications; and,
a presentation component adapted to present the data and/or results of data analysis.

13. A system according to claim 12, wherein a data record comprises a domain field which allows database information to be partitioned into different operational segments.

14. A system according to claim 12, wherein the communication data comprises data selected from a group which includes: the parties to the communication; and, the type, identity, time, duration and location of the communication.

15. A system according to claim 12, wherein the capture component is further adapted to capture performance data.

16. A system according to claim 15, wherein the performance data comprises data selected from a group which includes: volumes of sales, values of sales, volumes of commission and values of commission.

17. A system according to claim 12, wherein a system component is implemented as at least one server.

18. A system according to claims 17, wherein the capture component comprises distributed capture servers in communication with a transformation server.

19. A system according to claim 17, wherein a channel for organisational data or a communication modality is implemented as a plug-in module within the or each server.

20. A system according to claim 19, wherein each communication channel module is associated with a single type of communication modality selected from a group which includes: all forms of telephone, instant messaging, e-mail, telex, facsimile, web mail and a physical location identification system.

21. A system according to claim 20, wherein the physical location identification system comprises radio frequency identification (RFID).

22. A system according to claim 17, wherein a capture server module comprises an adapter to mediate capture of raw target data and to specify an appropriate form for the transformed data in dependence on the input format for a corresponding analysis module, the adapter comprising a transformation specification for specifying the data transformation.

23. A system according to claim 22, wherein the capture server module is configured as XML.

24. A system according to claim 17, wherein an analysis server comprises a reasoning engine or analytical tool package for performing queries and analysis on the data subject to user configurable options which tailor the operation to a particular environment.

25. A system according to claim 12, the system further comprising a database coupled to each of the capture, analysis and presentation components.

26. A system according to claim 25, wherein the database comprises a relational database.

27. A system according to claim 17, the system further comprising a data retrieval interface coupled to at least one of the capture, analysis and presentation servers.

28. A system according to claim 27, wherein the data retrieval interface is coupled to a source of raw communication and/or organisational data.

29. A system according to claim 27, the system further comprising a user interface.

30. A system according to claim 29, the system further comprising a user interface controller for coordinating interaction between the user interface and the data retrieval interface.

31. A system according to claim 29, wherein the user interface comprises a web-based interface.

32. A system according to claim 31, the system further comprising a user interface controller for coordinating interaction between the user interface and the data retrieval interface.
